(19) United States
(12) Patent Application Publication
(10) Pub. No.: US 2023/0074031 A1
(43) Pub. Date: Mar. 9, 2023

(54) Flexible Flat Cable for Improving High-frequency Transmission

(71) Applicant: Ying Hao Technology CO., LTD., New Taipei (TW)

(72) Inventor: Chih-Jung Chen, New Taipei (TW)

(73) Assignee: Ying Hao Technology CO., LTD., New Taipei (TW)

(21) Appl. No.: 17/813,317

(22) Filed: Jul. 18, 2022

(30) Foreign Application Priority Data
Sep. 3, 2021 (TW) 110210442

(51) Int. Cl. H01B 7/08; H01B 7/04

(52) U.S. Cl. CPC H01B 7/0838; H01B 7/0823; H01B 7/04

(57) ABSTRACT

Embodiments of the present disclosure are directed to a flexible flat cable for improving high-frequency transmission, which has a multi-layer structure. The flexible flat cable includes an upper plastic film layer, an upper adhesive film layer, a plurality of wires arranged in parallel, a lower adhesive film layer, and a lower plastic film layer in turn from top to bottom. At least two adjacent wires have a dielectric space, which is capable of reducing conductor loss, thereby reducing the attenuation of the signal and improving the signal integrity.

### CROSS REFERENCE TO RELATED APPLICATION

This application claims priority to Taiwanese Application No. 110210442, filed on Sep. 3, 2021. The entire disclosure of the above application is incorporated herein by reference.

### FIELD OF THE INVENTION

The present disclosure relates to a flexible flat cable, more particularly, to a flexible flat cable for improving high-frequency transmission.

BACKGROUND

The existing data transmission conductor cable developed by the industry can be used to connect two electronic devices or two circuit boards for high-frequency data transmissions, such as a flexible flat cable (FFC) or a flexible printed circuit cable. The flexible printed circuit cable can be produced as a single-sided, double-sided, and multi-layer flexible printed circuit cable by using a copper-coated substrate to etch. Generally, the flexible flat cable is made of an insulating material layer and extremely thin flat conductors, which are pressed together by automatic equipment. The flexible flat cable can be produced in large quantities automatically, and the distance between conductors can be accurately adjusted through the setting of the machine and fixture. Therefore, it is very suitable for the control of the high-frequency signal transmission. Moreover, the flexible flat cable has the characteristics of neatly arranged cores, large transmission capacity, flat structure, small size, and flexibility, and can be flexibly applied to all kinds of electronic products as a data transmission conductor cable.

When it is made of insulating materials and extremely thin flat transmission conductors pressed together by the automatic equipment, a plurality of flat conductors of the flexible flat cable are arranged in parallel, and then the upper and lower insulating material layers are attached from the upper and lower sides by an adhesive layer, and the flat conductors arranged in parallel are wrapped therein when the upper and lower insulating material layers adhered to each other at the same time.

Please refer to FIG. 1, which is a sectional view and a partial enlarged view of a flexible flat cable before and after lamination in the prior art. The sectional views of the flexible flat cable preparing for lamination, performing lamination, completing lamination, and partially enlarged are in the diagram respectively from top to bottom. As shown in the sectional view of preparing for lamination, the flexible flat cable in the prior art comprises: a plurality of wires 100 arranged in parallel and flat, an upper adhesive film layer 200, a lower adhesive film layer 300, an upper plastic film layer 400, and a lower plastic film layer 500 in turn from top to bottom. The wires 100 arranged in parallel and flat are used for transmitting electrical signals. The upper adhesive film layer 200 is located above the wires 100. The lower adhesive film layer 300 is located below the wires 100. The upper plastic film layer 400 is located above the upper adhesive film layer 200. The lower plastic film layer 500 is located below the lower adhesive film layer 300.

As shown in the sectional view of performing lamination, the upper plastic film layer 400 and the lower plastic film layer 500 clamp the wires 100 arranged in parallel and flat by the upper adhesive film layer 200 and the lower adhesive film layer 300. In general, when making a flexible flat cable in the industry, a thickness of the flat wires 100 is, for example, 0.02 mm, a thickness of the upper plastic film layer 400 and the lower plastic film layer 500 is, for example, 0.02 mm, and a thickness of the upper adhesive film layer 200 and the lower adhesive film layer 300 is, for example, 0.025 mm.

The thickness setting considerations of the upper adhesive film layer 200 and the lower adhesive film layer 200 mentioned above can be shown in the sectional views of completing lamination and partially enlarged. When the flexible flat cable after lamination, due to the total thickness of the upper adhesive film layer 200 and the lower adhesive film layer 300 (0.025 mm+0.025 mm=0.05 mm) is much greater than the thickness of the wires 100 (0.02 mm). The main purpose is to make the upper adhesive film layer 200 and the lower adhesive film layer 300 completely surround and wrap the wires 100 arranged in parallel and flat after lamination. That is, after completing lamination, as shown in the sectional view of partially enlarged, all spaces between the upper plastic film layer 400 and the lower plastic film layer 500, except for the wires 100, are filled with the fused upper adhesive film layer 200 and the lower adhesive film layer 300.

However, as the industry knows, although the flexible flat cable has many advantages mentioned above, it also uses flat conductors with extremely small thickness, resulting in a too-small conductor cross-sectional area and increased conductor electrical resistance, which is harmful to high-frequency transmission. Moreover, due to the skin effect, when the frequency is higher, the critical depth of the skin effect will be smaller, and the current will be more concentrated on the conductor surface, thereby increasing the equivalent resistance of the conductor. When a flat conductor is used, the current will be more concentrated on both ends of the flat conductor, thereby increasing the electrical resistance of the flat conductor. The two points are the main reasons for the high-frequency signal transmission loss of the existing flexible flat cable.

In order to reduce the loss of high-frequency signal transmission of the flexible flat cable and improve high-frequency signal transmission, the following two points can be considered: signal propagation delay and signal attenuation.

Signal propagation delay: in the system of high-speed signal transmission, signal propagation speed and signal attenuation are two very important parameters. The propagation delay of the signal depends on the value of the dielectric constant (Dk; εr) and the overall structure of the transmission line. Since the propagation time is directly proportional to the square root of the dielectric constant, if the transmission line material with a low dielectric constant is used, the propagation delay of the signal can be reduced, and the coupling capacitance between the conductors arranged in parallel can be decreased, thereby reducing the cross-talk between signals.

Signal attenuation: signal attenuation includes two factors: conductor loss and dielectric loss. The conductor loss also includes direct current (DC) resistance loss, alternating current (AC) resistance loss caused by skin effect, and loss caused by conductor roughness. The dielectric loss represents the loss of the signal in the transmission line material, which is usually described by the loss tangent or dissipation factor (Df). If the dielectric material with low loss is used, the attenuation of the signal can be reduced and the signal integrity can be improved.

With the design of connectors that are light, thin, short, and reasonably priced, it is bound to become the mainstream. However, under the premise of this mainstream, it is necessary to improve the high-frequency signal transmission performance and improve the high-frequency signal transmission. Therefore, this is the important issue that the present disclosure is eager to solve here.

### SUMMARY

In view of this, it is necessary to provide a flexible flat cable for improving high-frequency transmission to solve the problems in the prior art.

An embodiment of the present disclosure is directed to a flexible flat cable for improving high-frequency transmission, which has a multi-layer structure and comprises:

an upper plastic film layer, an upper adhesive film layer, a plurality of wires arranged in parallel, a lower adhesive film layer, and a lower plastic film layer in turn from top to bottom, and at least two adjacent wires have a dielectric space.

In addition, another embodiment of the present disclosure is directed to a flexible flat cable for improving high-frequency transmission. The flexible flat cable includes: a plurality of wires arranged in parallel for transmitting electrical signals, an upper adhesive film layer located above the wires, a lower adhesive film layer located below the wires, an upper plastic film layer located above the upper adhesive film layer, and a lower plastic film layer located below the lower adhesive film layer. The upper plastic film layer and the lower plastic film layer clamp the wires by the upper adhesive film layer and the lower adhesive film layer, and at least two adjacent wires are separated by a dielectric space.

Optionally, the wires are a plurality of flat conductors.

Optionally, a thickness of the flat conductors is greater than a total thickness of the upper adhesive film layer and the lower adhesive film layer.

Optionally, the wires are a plurality of round conductors.

Optionally, a diameter of the round conductors is greater than a total thickness of the upper adhesive film layer and the lower adhesive film layer.

Optionally, the upper plastic film layer has at least two first positions corresponding to the at least two adjacent wires and at least one second position corresponding to the dielectric space, the upper adhesive film layer is disposed at the at least two first positions, and the upper adhesive film layer is not disposed at the second position.

Optionally, the lower plastic film layer has at least two first positions corresponding to the at least two adjacent wires and at least one second position corresponding to the dielectric space. The lower adhesive film layer is disposed at the at least two first positions, and the lower adhesive film layer is not disposed at the second position.

Optionally, any of the two adjacent wires have the dielectric space.

Optionally, the dielectric space is filled with air.

When the signal transmission frequency is higher, the critical depth of the skin effect will be smaller, resulting in the rise of equivalent resistance and the concentration of current on the conductor surface. Compared with the existing flexible flat cable, the present disclosure increases the conductor thickness or adopts a round conductor with a larger diameter to increase the conductor cross-sectional area, which can reduce the conductor loss and reduce the signal propagation delay. Moreover, the dielectric space of the present disclosure is a dielectric material with very low dielectric loss, the attenuation of the signal can be reduced and the signal integrity can be improved.

Compared with the flexible flat cable in the prior art, the flexible flat cable of the present disclosure increases the conductor cross-sectional area, reduces the conductor loss of the flexible flat cable, and also reduces the equivalent resistance of the conductor through the skin effect. Moreover, the dielectric space is disposed between the two adjacent wires, which effectively improves the dielectric loss of the flexible flat cable, so as to improve the high-frequency signal transmission of the flexible flat cable.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a sectional view and a partial enlarged view of a flexible flat cable before and after lamination in the prior art.

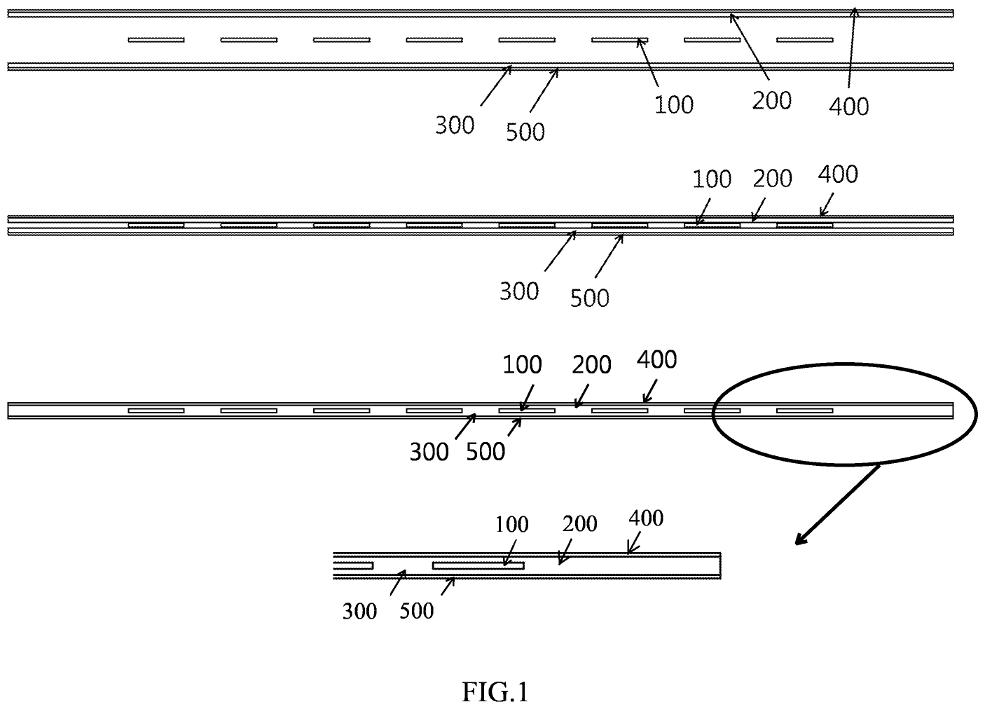

FIG. 2 is a sectional view of a flexible flat cable before and after lamination, and a partial enlarged view of the flexible flat cable after lamination according to first embodiment of the present disclosure.

FIG. 3 is a sectional view of the flexible flat cable before and after lamination, and a partial enlarged view of the flexible flat cable after lamination according to second embodiment of the present disclosure.

FIG. 4 is a perspective view according to first and second embodiments of the present disclosure.

FIG. 5 is a sectional view of the flexible flat cable before and after lamination, and a partial enlarged view of the flexible flat cable after lamination according to third embodiment of the present disclosure.

FIG. 6 is a sectional view of the flexible flat cable before and after lamination, and a partial enlarged view of the flexible flat cable after lamination according to fourth embodiment of the present disclosure.

FIG. 7 is a sectional view of the flexible flat cable before and after lamination, and a partial enlarged view of the flexible flat cable after lamination according to fifth embodiment of the present disclosure.

FIG. 8 is a perspective view according to fourth and fifth embodiments of the present disclosure.

### DESCRIPTION OF THE EMBODIMENTS

To help a person skilled in the art better understand the solutions of the present disclosure, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present disclosure.

It should further be understood that, although the terms first, second, third, and the like may be used herein to describe various elements, components, regions, layers and/or sections, these elements, components, regions, layers and/or sections should not be limited by these terms. These terms are used only to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

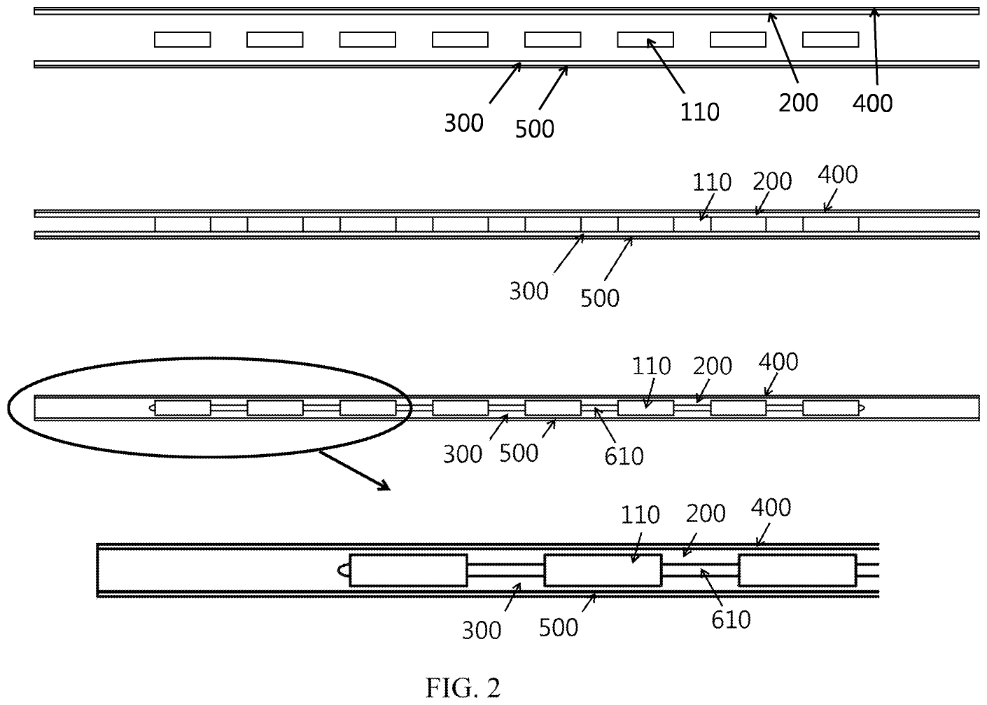

Please refer to FIG. 2, which is a sectional view of a flexible flat cable before and after lamination, and a partial enlarged view of the flexible flat cable after lamination according to first embodiment of the present disclosure. The sectional views of the flexible flat cable according to the first embodiment of the present disclosure preparing for lamination, performing lamination, completing lamination, and partially enlarged are in the diagram respectively from top to bottom. As shown in the sectional view of preparing for lamination, the flexible flat cable of the first embodiment has a multi-layer structure and comprises: a plurality of wires 110 (thicker than the conductors in the prior art) arranged in parallel and flat, an upper adhesive film layer 200, a lower adhesive film layer 300, an upper plastic film layer 400, and a lower plastic film layer 500 in turn from top to bottom. The wires 110 arranged in parallel and flat are used for transmitting electrical signals. The upper adhesive film layer 200 is located above the wires 110. The lower adhesive film layer 300 is located below the wires 110. The upper plastic film layer 400 is located above the upper adhesive film layer 200. The lower plastic film layer 500 is located below the lower adhesive film layer 300.

As shown in the sectional view of performing lamination, the upper plastic film layer 400 and the lower plastic film layer 500 clamp the wires 110 arranged in parallel and flat by the upper adhesive film layer 200 and the lower adhesive film layer 300, and at least two adjacent wires 110 have a dielectric space 610 therein. When making the flexible flat cable of the first embodiment, a thickness of the flat wires 110 is, for example, 0.08 mm (thicker than the conductors in the prior art), a thickness of the upper plastic film layer 400 and the lower plastic film layer 500 is, for example, 0.02 mm, and a thickness of the upper adhesive film layer 200 and the lower adhesive film layer 300 is, for example, 0.025 mm.

When the flexible flat cable after lamination, as shown in the sectional views of completing lamination and partially enlarged, due to the total thickness of the upper adhesive film layer 200 and the lower adhesive film layer 300 (0.025 mm+0.025 mm=0.05 mm) is less than the thickness of the wires 110 (0.08 mm). The main purpose is to provide the dielectric space 610 between the at least two adjacent wires 110 after lamination.

In this embodiment, any of the two adjacent wires 110 have the dielectric space 610. Moreover, the dielectric space 610 is air in this embodiment. In the first embodiment of the present disclosure, the thickness of the wires 110 is increased, and the dielectric space 610 is disposed between any of the two adjacent wires 110 at the same time. The dielectric constant of the air is 1.000585. It can reduce conductor loss, the attenuation of the signal can be reduced and the signal integrity can be improved. Therefore, the high-frequency transmission characteristics of the flexible flat cable are effectively improved.

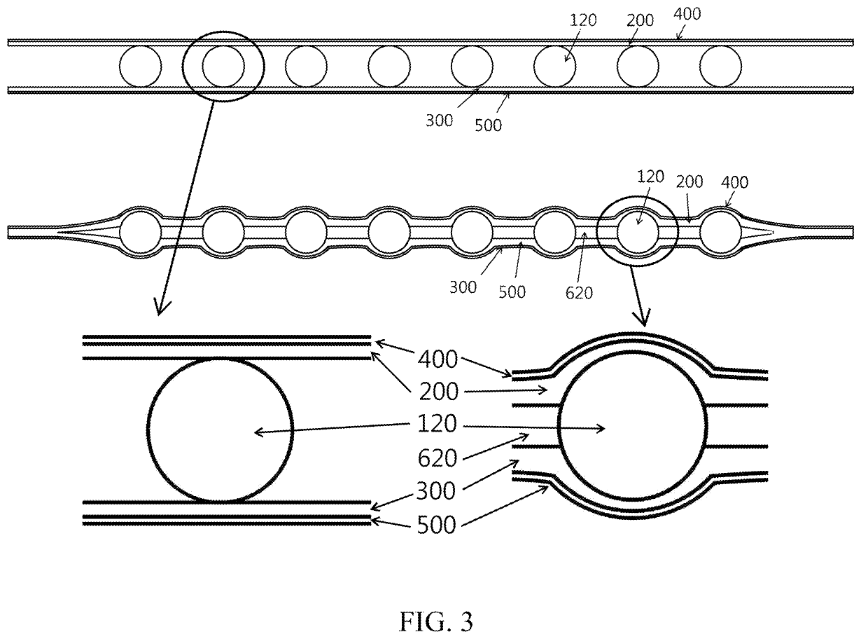

Please refer to FIG. 3, which is a sectional view of the flexible flat cable before and after lamination, and a partial enlarged view of the flexible flat cable after lamination according to second embodiment of the present disclosure. The sectional views of the flexible flat cable according to the first embodiment of the present disclosure performing lamination, completing lamination, and partially enlarged are in the diagram respectively from top to bottom. As shown in the sectional view of performing lamination, the flexible flat cable of the second embodiment has a multi-layer structure and comprises: a plurality of wires 120 arranged in parallel and round, an upper adhesive film layer 200, a lower adhesive film layer 300, an upper plastic film layer 400, and a lower plastic film layer 500 in turn from top to bottom. The wires 120 arranged in parallel and round are used for transmitting electrical signals. The upper adhesive film layer 200 is located above the wires 120. The lower adhesive film layer 300 is located below the wires 120. The upper plastic film layer 400 is located above the upper adhesive film layer 200. The lower plastic film layer 500 is located below the lower adhesive film layer 300.

As shown in the sectional view of performing lamination, the upper plastic film layer 400 and the lower plastic film layer 500 clamp the wires 120 arranged in parallel and round by the upper adhesive film layer 200 and the lower adhesive film layer 300, and at least two adjacent round wires 120 have a larger dielectric space 620 therein. When making the flexible flat cable of the second embodiment, a diameter of the wires 110 arranged in parallel and round is, for example, 0.25 mm, a thickness of the upper plastic film layer 400 and the lower plastic film layer 500 is, for example, 0.02 mm, and a thickness of the upper adhesive film layer 200 and the lower adhesive film layer 300 is, for example, 0.025 mm. When the flexible flat cable after lamination, as shown in the sectional views of completing lamination and partially enlarged, due to the total thickness of the upper adhesive film layer 200 and the lower adhesive film layer 300 (0.025 mm+0.025 mm=0.05 mm) is less than the diameter of the round wires 120 (0.25 mm). The main purpose is to provide the larger dielectric space 620 between the at least two adjacent round wires 120 after lamination.

In this embodiment, any of the two adjacent round wires 120 have the larger dielectric space 620. Moreover, the dielectric space 620 is air in this embodiment. In the second embodiment of the present disclosure, the round wires 120 with a larger diameter are adopted, and the larger dielectric space 620 is disposed between any of the two adjacent round wires 120 at the same time. The dielectric constant of the air is 1.000585. It can reduce conductor loss, the attenuation of the signal can be reduced and the signal integrity can be improved. Therefore, the high-frequency transmission characteristics of the flexible flat cable are effectively improved.

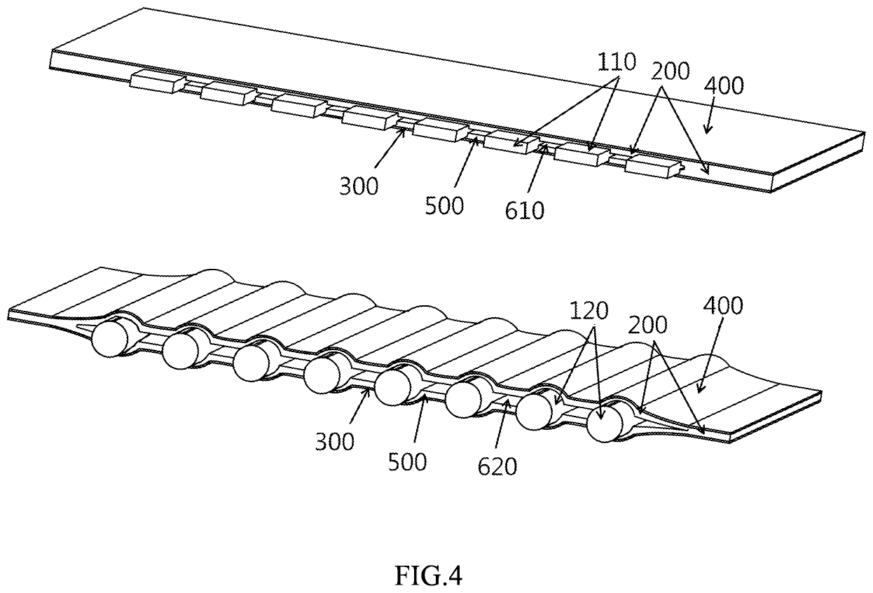

Please refer to FIG. 4, which is a perspective view according to the first and second embodiments of the present disclosure. The existence of dielectric space 610 and larger dielectric space 620 can be clearly observed in this three-dimensional diagram. It is worth mentioning that the thickness of various wires, adhesive film layers, and plastic film layers mentioned above is only an example rather than a limitation of the present disclosure. Only if the thickness of various wires, adhesive film layers, and plastic film layers is properly set, and the pressure, temperature, or other process parameters of lamination are properly controlled, so that the dielectric space is disposed between adjacent wires, which is covered by the creative spirit of the present disclosure.

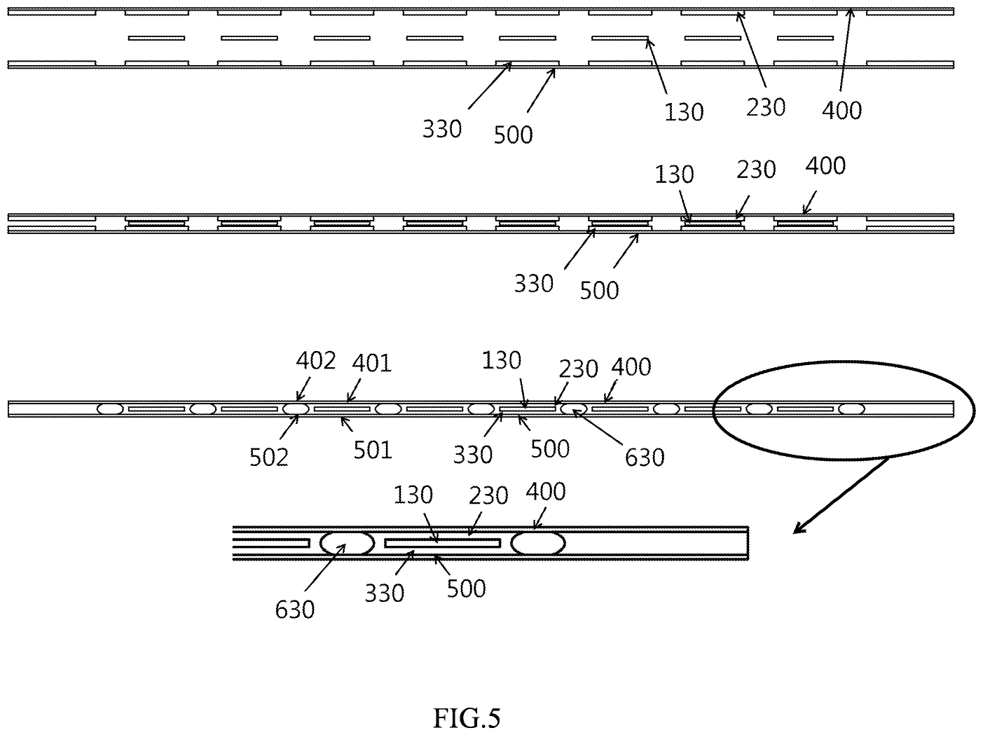

Please refer to FIG. 5, which is a sectional view of the flexible flat cable before and after lamination, and a partial enlarged view of the flexible flat cable after lamination according to third embodiment of the present disclosure. The sectional views of the flexible flat cable according to the third embodiment of the present disclosure preparing for lamination, performing lamination, completing lamination, and partially enlarged are in the diagram respectively from top to bottom. As shown in the sectional view of preparing for lamination, the flexible flat cable of the third embodiment has a multi-layer structure and comprises: a plurality of wires 130 arranged in parallel and flat, an upper adhesive film layer 230, a lower adhesive film layer 330, an upper plastic film layer 400, and a lower plastic film layer 500 in turn from top to bottom. The wires 130 arranged in parallel and flat are used for transmitting electrical signals. The upper adhesive film layer 230 is located above the wires 130. The lower adhesive film layer 330 is located below the wires 130. The upper plastic film layer 400 is located above the upper adhesive film layer 230. The lower plastic film layer 500 is located below the lower adhesive film layer 330.

As shown in the sectional view of performing lamination, the upper plastic film layer 400 and the lower plastic film layer 500 clamp the wires 130 arranged in parallel and flat by the upper adhesive film layer 230 and the lower adhesive film layer 330, and at least two adjacent wires 130 have a dielectric space 630 therein. When making the flexible flat cable of the third embodiment, a thickness of the flat wires 130 is, for example, 0.02 mm (the existing thickness of the conductors in the prior art), a thickness of the upper plastic film layer 400 and the lower plastic film layer 500 is, for example, 0.02 mm, and a thickness of the upper adhesive film layer 230 and the lower adhesive film layer 330 is, for example, 0.025 mm. When the flexible flat cable after lamination, as shown in the sectional views of completing lamination and partially enlarged, the upper plastic film layer 400 has at least two first positions 401 corresponding to the at least two adjacent wires 130 and at least one second position 402 corresponding to the dielectric space 630, the upper adhesive film layer 230 is disposed at the at least two first positions 401, and the upper adhesive film layer 230 is not disposed at the second position 402. Moreover, the lower plastic film layer 500 has at least two first positions 501 corresponding to the at least two adjacent wires 130 and at least one second position 502 corresponding to the dielectric space 630, the lower adhesive film layer 330 is disposed at the at least two first positions 501, and the lower adhesive film layer 330 is not disposed at the second position 502. Although the total thickness of the upper adhesive film layer 230 and the lower adhesive film layer 330 (0.025 mm+0.025 mm=0.05 mm) is greater than the thickness of the wires 130 (0.02 mm), the upper and lower adhesive film layers 230, 330 are disposed at the first positions 401, 501 corresponding to the wires 130, while the upper and lower adhesive film layers 230, 330 are not disposed at the second positions 402, 502 of the present disclosure. The main purpose is to enable at least two adjacent flat wires 130 to have the dielectric space 630 even though the thickness of the flat wires 130 is less than the total thickness of the upper and lower adhesive layers 230, 330 after lamination.

In this embodiment, any of the two adjacent flat wires 130 have the dielectric space 630. Moreover, the dielectric space 630 is air in this embodiment. In the third embodiment of the present disclosure, the thickness of the flat wires 130 is not increased, but by disposing the upper and lower adhesive film layers 230, 330 at the first positions 401, 501 only corresponding to the wires 130, and omitting the upper and lower adhesive film layers 230, 330 at the second positions 402, 502 other than the positions of the wires 130, the dielectric space 610 can still be disposed between any of the two adjacent flat wires 130, and the dielectric constant of the air is 1.000585. It can reduce conductor loss, the attenuation of the signal can be reduced and the signal integrity can be improved. Therefore, the high-frequency transmission characteristics of the flexible flat cable are effectively improved.

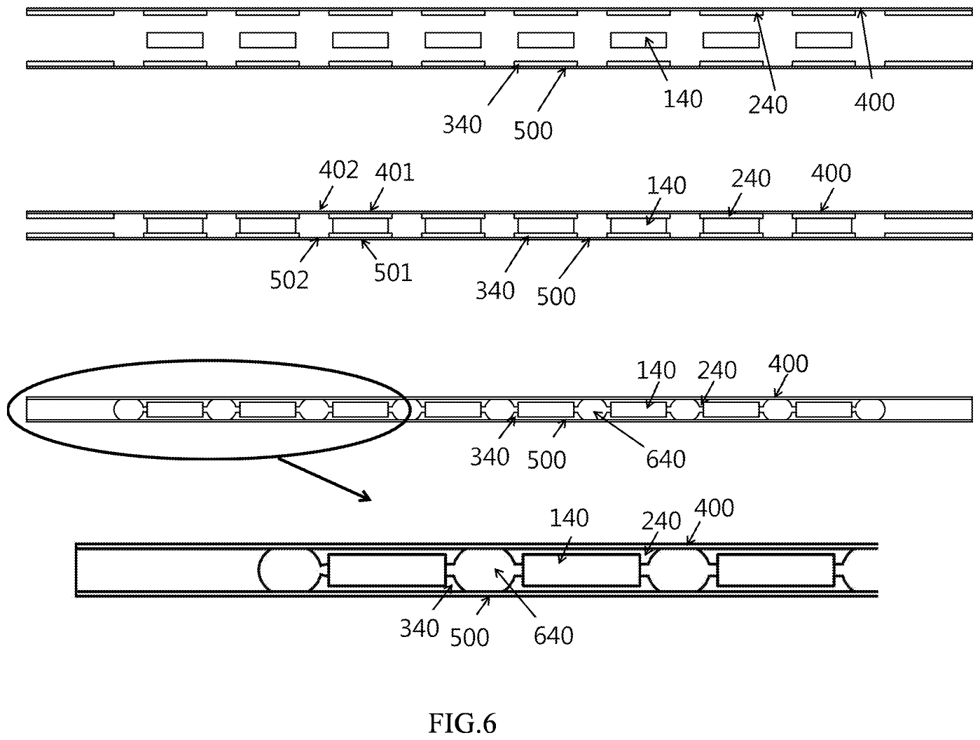

Please refer to FIG. 6, which is a sectional view of the flexible flat cable before and after lamination, and a partial enlarged view of the flexible flat cable after lamination according to fourth embodiment of the present disclosure. The sectional views of the flexible flat cable according to the fourth embodiment of the present disclosure preparing for lamination, performing lamination, completing lamination, and partially enlarged are in the diagram respectively from top to bottom. As shown in the sectional view of preparing for lamination, the flexible flat cable of the fourth embodiment has a multi-layer structure and comprises: a plurality of wires 140 (thicker than the conductors in the prior art) arranged in parallel and flat, an upper adhesive film layer 240, a lower adhesive film layer 340, an upper plastic film layer 400, and a lower plastic film layer 500 in turn from top to bottom. The wires 140 arranged in parallel and flat are used for transmitting electrical signals. The upper adhesive film layer 240 is located above the wires 140. The lower adhesive film layer 340 is located below the wires 140. The upper plastic film layer 400 is located above the upper adhesive film layer 240. The lower plastic film layer 500 is located below the lower adhesive film layer 340.

As shown in the sectional view of performing lamination, the upper plastic film layer 400 and the lower plastic film layer 500 clamp the wires 140 arranged in parallel and flat by the upper adhesive film layer 240 and the lower adhesive film layer 340, and at least two adjacent wires 140 have a dielectric space 640 therein. When making the flexible flat cable of the fourth embodiment, a thickness of the flat wires 140 is, for example, 0.08 mm (thicker than the conductors in the prior art), a thickness of the upper plastic film layer 400 and the lower plastic film layer 500 is, for example, 0.02 mm, and a thickness of the upper adhesive film layer 240 and the lower adhesive film layer 340 is, for example, 0.025 mm. When the flexible flat cable after lamination, as shown in the sectional views of completing lamination and partially enlarged, the upper plastic film layer 400 has at least two first positions 401 corresponding to the at least two adjacent wires 140 and at least one second position 402 corresponding to the dielectric space 640, the upper adhesive film layer 240 is disposed at the at least two first positions 401, and the upper adhesive film layer 240 is not disposed at the second position 402. Moreover, the lower plastic film layer 500 has at least two first positions 501 corresponding to the at least two adjacent wires 140 and at least one second position 502 corresponding to the dielectric space 640, the lower adhesive film layer 340 is disposed at the at least two first positions 501, and the lower adhesive film layer 340 is not disposed at the second position 502. Due to the total thickness of the upper adhesive film layer 240 and the lower adhesive film layer 340 (0.025 mm+0.025 mm=0.05 mm) is less than the thickness of the wires 140 (0.08 mm). Further, the upper and lower adhesive film layers 240, 340 are only disposed at the first positions 401, 501 corresponding to the wires 140, while the upper and lower adhesive film layers 240, 340 are not disposed at the second positions 402, 502 of the fourth embodiment of the present disclosure. The main purpose is to make the thickness of the flat wires 140 is greater than the total thickness of the upper and lower adhesive film layers 240, 340 after lamination. In addition, the upper and lower adhesive film layers 240, 340 are selectively disposed or not disposed at the first positions 401, 501 and the second positions 402, 502, so that a larger dielectric space 640 can be disposed between the at least two adjacent flat wires 140.

In this embodiment, any of the two adjacent flat wires 140 have the larger dielectric space 640. Moreover, the dielectric space 640 is air in this embodiment. In the fourth embodiment of the present disclosure, not only the thickness of the wires 140 is increased, but also by disposing the upper and lower adhesive film layers 240, 340 at the first positions 401, 501 corresponding to the wires 140, and omitting the upper and lower adhesive film layers 240, 340 at the second positions 402, 502 other than the positions of the wires 140, the larger dielectric space 640 is disposed between any of the two adjacent wires 140, and the dielectric constant of the air is 1.000585. It can reduce conductor loss, the attenuation of the signal can be reduced and the signal integrity can be improved. Therefore, the high-frequency transmission characteristics of the flexible flat cable are effectively improved.

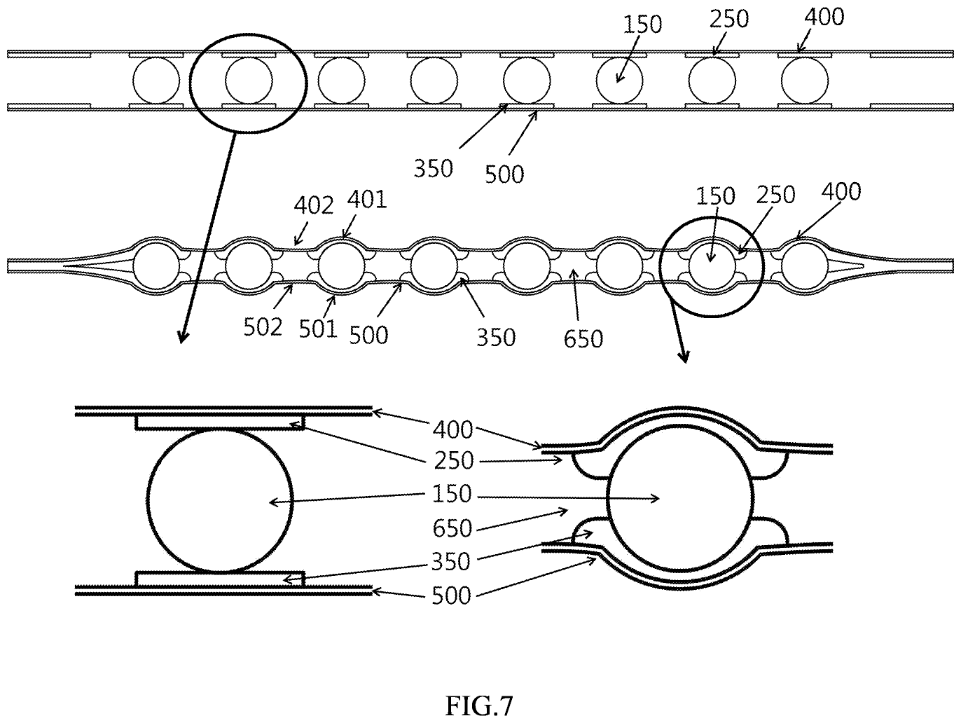

Please refer to FIG. 7, which is a sectional view of the flexible flat cable before and after lamination, and a partial enlarged view of the flexible flat cable after lamination according to fifth embodiment of the present disclosure. The sectional views of the flexible flat cable according to the fifth embodiment of the present disclosure performing lamination, completing lamination, and partially enlarged are in the diagram respectively from top to bottom. As shown in the sectional view of performing lamination, the flexible flat cable of the fifth embodiment has a multi-layer structure and comprises: a plurality of wires 150 arranged in parallel and round, an upper adhesive film layer 250, a lower adhesive film layer 350, an upper plastic film layer 400, and a lower plastic film layer 500 in turn from top to bottom. The wires 150 arranged in parallel and round are used for transmitting electrical signals. The upper adhesive film layer 250 is located above the wires 150. The lower adhesive film layer 350 is located below the wires 150. The upper plastic film layer 400 is located above the upper adhesive film layer 250. The lower plastic film layer 500 is located below the lower adhesive film layer 350.

As shown in the sectional view of performing lamination, the upper plastic film layer 400 and the lower plastic film layer 500 clamp the wires 150 arranged in parallel and round by the upper adhesive film layer 250 and the lower adhesive film layer 350, and at least two adjacent round wires 150 have a dielectric space 650 therein. When making the flexible flat cable of the fifth embodiment, a diameter of the wires 150 arranged in parallel and round is, for example, 0.25 mm, a thickness of the upper plastic film layer 400 and the lower plastic film layer 500 is, for example, 0.02 mm, and a thickness of the upper adhesive film layer 250 and the lower adhesive film layer 350 is, for example, 0.025 mm. When the flexible flat cable after lamination, as shown in the sectional views of completing lamination and partially enlarged, the upper plastic film layer 400 has at least two first positions 401 corresponding to the at least two adjacent round wires 150 and at least one second position 402 corresponding to the dielectric space 650, the upper adhesive film layer 250 is disposed at the at least two first positions 401, and the upper adhesive film layer 250 is not disposed at the second position 402. Moreover, the lower plastic film layer 500 has at least two first positions 501 corresponding to the at least two adjacent round wires 150 and at least one second position 502 corresponding to the dielectric space 650, the lower adhesive film layer 350 is disposed at the at least two first positions 501, and the lower adhesive film layer 350 is not disposed at the second position 502. Due to the total thickness of the upper adhesive film layer 250 and the lower adhesive film layer 350 (0.025 mm+0.025 mm=0.05 mm) is less than the diameter of the round wires 150. Further, the upper and lower adhesive film layers 250, 350 are only disposed at the first positions 401, 501 corresponding to the wires 150, while the upper and lower adhesive film layers 250, 350 are not disposed at the second positions 402, 502 of the fifth embodiment of the present disclosure. The main purpose is to make the thickness of the round wires 150 is greater than the total thickness of the upper and lower adhesive film layers 250, 350 after lamination. In addition, the upper and lower adhesive film layers 250, 350 are selectively disposed or not disposed at the first positions 401, 501 and the second positions 402, 502, so that the much larger dielectric space 650 can be disposed between the at least two adjacent round wires 150.

In this embodiment, any of the two adjacent round wires 150 have the much larger dielectric space 650. Moreover, the dielectric space 650 is air in this embodiment. In the fifth embodiment of the present disclosure, the thickness of the wires 150 is increased, by disposing the upper and lower adhesive film layers 250, 350 at the first positions 401, 501 corresponding to the wires 150, and omitting the upper and lower adhesive film layers 250, 350 at the second positions 402, 502 other than the positions of the wires 150, the much larger dielectric space 650 is disposed between any of the two adjacent round wires 150, and the dielectric constant of the air is 1.000585. It can reduce conductor loss, the attenuation of the signal can be reduced and the signal integrity can be improved. Therefore, the high-frequency transmission characteristics of the flexible flat cable are effectively improved.

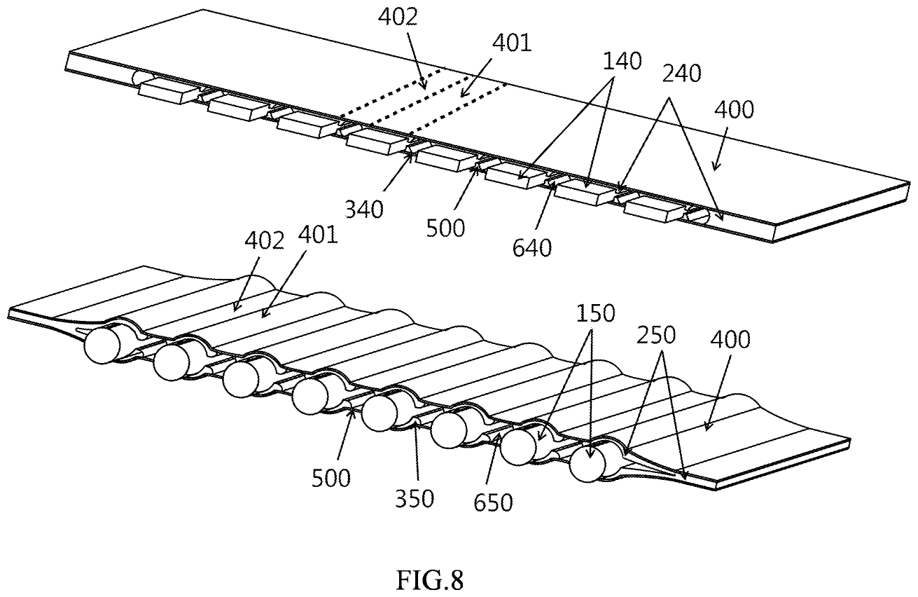

Please refer to FIG. 8, which is a perspective view according to the fourth and fifth embodiments of the present disclosure. The existence of larger dielectric space 640 and much larger dielectric space 650 can be clearly observed in this three-dimensional diagram. It is worth mentioning that the thickness of various wires, adhesive film layers, and plastic film layers mentioned above is only an example rather than a limitation of the present disclosure. Only if the thickness of various wires, adhesive film layers, and plastic film layers is properly set, and the pressure, temperature, or other process parameters of lamination are properly controlled, so that the dielectric space is disposed between adjacent wires, which is covered by the creative spirit of the present disclosure.

Compared with the flexible flat cable in the prior art, the flexible flat cable of the present disclosure increases the conductor cross-sectional area, reduces the conductor loss of the flexible flat cable, and also reduces the equivalent resistance of the conductor through the skin effect. Moreover, the dielectric space is disposed between the two adjacent wires, which effectively improves the dielectric loss of the flexible flat cable, so as to improve the high-frequency signal transmission of the flexible flat cable.

While the embodiments of the present disclosure have been shown and described above, it is to be understood that the above embodiments are exemplary and are not to be construed as limiting the present disclosure. One of ordinary skill in the art may make variations, modifications, substitutions and alterations to the above embodiments within the scope of the present disclosure.

What is claimed is:

1. A flexible flat cable, comprising:
a plurality of wires, arranged in parallel for transmitting electrical signals;
an upper adhesive film layer, located above the wires;
a lower adhesive film layer, located below the wires;
an upper plastic film layer, located above the upper adhesive film layer; and
a lower plastic film layer, located below the lower adhesive film layer;
wherein the upper plastic film layer and the lower plastic film layer clamp the wires by the upper adhesive film layer and the lower adhesive film layer, and at least two adjacent wires are separated by a dielectric space.

2. The flexible flat cable as claimed in claim 1, wherein the wires are a plurality of flat conductors.

3. The flexible flat cable as claimed in claim 2, wherein a thickness of the flat conductors is greater than a total thickness of the upper adhesive film layer and the lower adhesive film layer.

4. The flexible flat cable as claimed in claim 1, wherein the wires are a plurality of round conductors.

5. The flexible flat cable as claimed in claim 4, wherein a diameter of the round conductors is greater than a total thickness of the upper adhesive film layer and the lower adhesive film layer.

6. The flexible flat cable as claimed in claim 1, wherein the upper plastic film layer has at least two first positions corresponding to the at least two adjacent wires and at least one second position corresponding to the dielectric space, the upper adhesive film layer is disposed at the at least two first positions, and the upper adhesive film layer is not disposed at the second position.

7. The flexible flat cable as claimed in claim 1, wherein the lower plastic film layer has at least two first positions corresponding to the at least two adjacent wires and at least one second position corresponding to the dielectric space, the lower adhesive film layer is disposed at the at least two first positions, and the lower adhesive film layer is not disposed at the second position.

8. The flexible flat cable as claimed in claim 1, wherein any of the two adjacent wires are separated by a dielectric space.

9. The flexible flat cable as claimed in claim 1, wherein the dielectric space is filled with air.

10. A flexible flat cable having a multi-layer structure, comprising: an upper plastic film layer, an upper adhesive film layer, a plurality of wires arranged in parallel, a lower adhesive film layer, and a lower plastic film layer in turn from top to bottom, wherein at least two adjacent wires are separated by a dielectric space.

11. The flexible flat cable as claimed in claim 10, wherein the wires are a plurality of flat conductors.

12. The flexible flat cable as claimed in claim 11, wherein a thickness of the flat conductors is greater than a total thickness of the upper adhesive film layer and the lower adhesive film layer.

13. The flexible flat cable as claimed in claim 10, wherein the wires are a plurality of round conductors.

14. The flexible flat cable as claimed in claim 13, wherein a diameter of the round conductors is greater than a total thickness of the upper adhesive film layer and the lower adhesive film layer.

15. The flexible flat cable as claimed in claim 10, wherein the upper plastic film layer has at least two first positions corresponding to the at least two adjacent wires and at least one second position corresponding to the dielectric space, the upper adhesive film layer is disposed at the at least two first positions, and the upper adhesive film layer is not disposed at the second position.

16. The flexible flat cable as claimed in claim 10, wherein the lower plastic film layer has at least two first positions corresponding to the at least two adjacent wires and at least one second position corresponding to the dielectric space, the lower adhesive film layer is disposed at the at least two first positions, and the lower adhesive film layer is not disposed at the second position.

17. The flexible flat cable as claimed in claim 10, wherein any of the two adjacent wires are separated by the dielectric space.

18. The flexible flat cable as claimed in claim 10, wherein the dielectric space is filled with air.
